(19) United States
(12) Patent Application Publication
(10) Pub. No.: US 2024/0386803 A1
(43) Pub. Date: Nov. 21, 2024

(54) SYSTEMS AND METHODS FOR IDENTIFYING AN ACTIVE RUNWAY AT AN AIRPORT

(71) Applicant: THE BOEING COMPANY, Arlington, VA (US)

(72) Inventors: William Jenden, Vancouver (CA); Albert Klaus-Dieter, Neu-Isenburg (DE); David Fundter, Gaiberg (DE); Yun Chu, New Westminster (CA)

(73) Assignee: THE BOEING COMPANY, Arlington, VA (US)

(21) Appl. No.: 18/318,091

(22) Filed: May 16, 2023

(51) Int. Cl. G08G 5/02; G08G 5/00

(52) U.S. Cl. CPC G08G 5/02; G08G 5/0017

(57) ABSTRACT

A system and a method include a control unit for determining status (such as active arrival or active departure) for one or more runways at one or more airports. The control unit is configured to detect one or more aspects of one or more aircraft in relation to the one or more runways, and determine the status of the one or more runways based on the one or more aspects of the one or more aircraft in relation to the one or more runways.

### FIELD OF THE DISCLOSURE

Examples of the present disclosure generally relate to systems and methods for determining status of runways at an airport, and more particularly to identifying one or more active runways at one or more airports.

### BACKGROUND OF THE DISCLOSURE

Aircraft are used to transport passengers and cargo between various locations. Numerous aircraft depart from and arrive at a typical airport every day.

Large airports include multiple runways. At any given time, one or more of the runways are active. An active runway is one that is currently being used for arrivals (that is, landings), and/or departures (that is, take-offs).

Pilots, dispatchers, air traffic control personnel, and the like need to know which runways are active at an airport. In order to determine which runways are active, individuals can rely on audio records or difficult-to-parse text in conjunction with current airport weather and runway information. However, such information may not all be available at a particular time and/or at particular airports.

As another example, air navigation service providers like the United States Federal Aviation Administration (FAA) and EuroControl provide active runway information through System Wide Information Management (SWIM) services. However, it has been found that such data is often delayed, and may not always be reliable. Further, such data may be limited to particular airports in particular jurisdictions, and data formats and connection mechanisms may vary.

### SUMMARY OF THE DISCLOSURE

A need exists for an efficient, effective, reliable, and accurate system and method for identifying active runways at airports.

With that need in mind, certain examples of the present disclosure provide a system including a control unit for determining status for one or more runways at one or more airports. The control unit is configured to detect one or more aspects of one or more aircraft in relation to the one or more runways, and determine the status of the one or more runways based on the one or more aspects of the one or more aircraft in relation to the one or more runways.

In at least one example, the status of the one or more runways includes an active runway. For example, the status of the one or more runways includes an active arrival runway and an active departure runway.

In at least one example, the one or more runways include a plurality of runways, and the one or more airports include one airport. In at least one other example, the one or more runways include a plurality of runways, and wherein the one or more airports include a plurality of airports.

In at least one example, the one or more aspects include altitude, speed, and heading.

In at least one example, the control unit is configured to determine the status based on a plurality of aircraft in relation to the one or more runways within a predetermined time threshold.

In at least one example, the control unit is configured to determine the status of the one or more runways as one or both of an active arrival runway or an active departure runway based on the one or more aspects of the one or more aircraft in relation to opposite ends of the one or more runways.

The control unit can be configured to determine that a runway is inactive in response to detecting different aircraft at opposite ends of the runway at the same time. The control unit can be configured to determine that two different parallel runways are not active in opposite directions.

In at least one example, the control unit is further configured to determine a configuration change of the one or more runways based on the one or more aspects of the one or more aircraft in relation to the one or more runways over time.

In at least one example, the control unit is further configured to output one or more runway status signals including data regarding the status of the one or more runways. One or more of the aircraft can be automatically operated based on the one or more runway status signals.

The control unit can be an artificial intelligence or machine learning system.

Certain examples of the present disclosure provide a method including detecting, by a control unit for determining status for one or more runways at one or more airports, one or more aspects of one or more aircraft in relation to the one or more runways; and determining, by the control unit, the status of the one or more runways based on the one or more aspects of the one or more aircraft in relation to the one or more runways.

Certain examples of the present disclosure provide a non-transitory computer-readable storage medium comprising executable instructions that, in response to execution, cause one or more control units comprising a processor, to perform operations including detecting one or more aspects of one or more aircraft in relation to one or more runways of one or more airports; and determining the status of the one or more runways based on the one or more aspects of the one or more aircraft in relation to the one or more runways.

### BRIEF DESCRIPTION OF THE DRAWINGS

FIG. 1 illustrates a schematic block diagram of system for identifying active runways at airports, according to an example of the present disclosure.

FIG. 2 illustrates a representation of an airport map, according to an example of the present disclosure.

FIG. 3 illustrates a flow chart of a method, according to an example of the present disclosure.

FIG. 4 illustrates a schematic block diagram of a control unit, according to an example of the present disclosure.

FIG. 5 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, examples of the present disclosure provide systems and methods configured to identify and track active runways at airports. The active runways are used for arrivals or departures at an airport at any point in time. The systems and methods are configured to identify the active runways based on tracked positions of aircraft in relation to runways at the airport. In at least one example, the systems and methods continuously track the active runways, and are configured to quickly and intelligently adapt when runway configuration is changed.

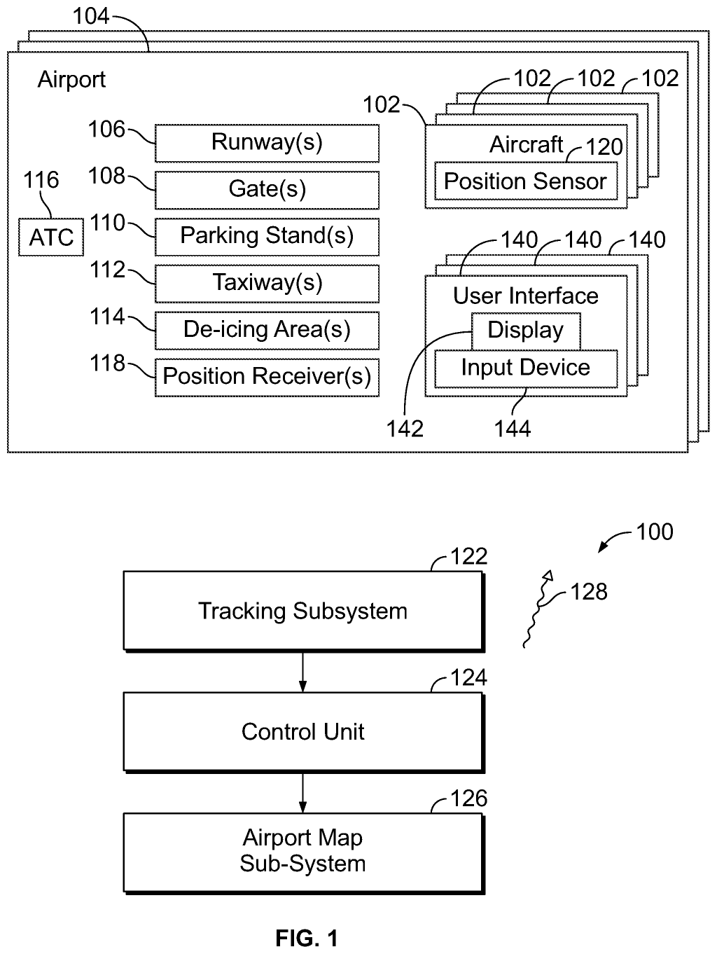

FIG. 1 illustrates a schematic block diagram of a system 100 for identifying active runways at airports, according to an example of the present disclosure. The system 100 is configured to identify active runways, and output data regarding the active runways to aircraft 102 (for example, pilots of the aircraft), dispatchers, air traffic control personnel, and the like at one or more airports 104. In one example, the system 100 is configured to identify active runways at numerous airports 104, such as a plurality of airports 104 within a city (for example, O'Hare International Airport and Midway International Airport in Chicago, Illinois), a state, a region including one or more states, one or more countries, a hemisphere, or the entire world. In a further example, the system 100 is configured to identify active runways at all of the airports 104 in such regions. In another example, the system 100 is configured to identify active runways at less than all of the airports 104 in such regions. As another example, the system 100 is configured to identify active runways at a single airport 104.

The airports 104 include various areas, such as one or more runways 106, one or more gates 108, one or more parking stands 110, one or more taxiways 112. one or more de-icing areas 114, and the like. In at least one example, an airport includes multiple runways 106. At any given time, a certain number of the runways 106 are active in that they are being used for arrivals and/or departures. In contrast, an inactive runway is not currently being used for arrivals and/or departures. The airports 104 also include air traffic control (ATC) 116, which is configured to coordinate and schedule takeoff and landing of the aircraft 102 at the airports 104. The aircraft 102 are configured to travel among the runway(s) 106, the gate(s) 108, the parking stand(s) 110, the taxiway(s) 112, and the de-icing areas 114 at the airports 104. For example, the aircraft 102 are de-iced (that is, undergo de-icing operations) at the de-icing area(s) 114 of an airport(s) 104.

Positions of the aircraft 102 at the airports 104 are detected by one or more position receivers 118 that receive position signals output by position sensors 120 of the aircraft 102. For example, the position receivers 118 are automatic dependent surveillance-broadcast (ADS-B) receivers that receive ADS-B signals output by the positions sensors 120 of the aircraft 102. As another example, the position sensor 120 can be a global positioning system sensor. The position sensor 120 outputs a signal indicative of one or more of the position, altitude, heading, acceleration, velocity, and/or the like of the aircraft 102. The signal is received by the position receiver(s) 118, which is in communication with a tracking sub-system 122 of the system 100.

The system 100 includes a control unit 124 in communication with the tracking sub-system 122, and an airport map sub-system 126 (such as a database, datastore, map control unit, and/or the like), such as through one or more wired or wireless connections. Each of the control unit 124, the tracking sub-system 122, and the airport map sub-system 126 can be remotely located from one another, or located at a common location (or a first subset can be commonly located, while a second subset, whether commonly located or not, can be remotely located from the first subset). The components of the system 100 can be located at an airport 104 or remotely located from the airport(s) 104. In at least one example, the control unit 124 correlates the position of the aircraft 102, as tracked via the tracking sub-system 122, in relation to a map of the airport 104, as stored in the airport map sub-system 126.

A user interface 140 includes a display 142 and an input device 144, both of which can be in communication with the control unit 124. The display 142 can be a monitor, screen, television, touchscreen, and/or the like. The input device 144 can include a keyboard, mouse, stylus, touchscreen interface (that is, the input device 144 can be integral with the display 142), and/or the like.

In at least one example, each aircraft 102 includes a user interface 140. For example, a user interface 140 can be in communication with and/or form a part of a flight computer of an aircraft 102. As another example, a user interface 140 can be part of a separate computer workstation aboard an aircraft 102. As another example, the user interface 140 can be a handheld device, such as a smart phone, tablet, or the like, within an aircraft 102. Optionally, the user interface 140 can be located remotely from the aircraft 102, such as at an air traffic control location, a ground control location, and/or the like. As another example, an application programming interface (API) can be used to distribute data to various types of devices, such as a handheld device, a user interface, and/or the like.

The control unit 124 can be in communication with the user interface(s) 140 through one or more wired (if at the same location), or wireless connections. For example, the control unit 124 can include a communication device, such as one or more antennas, transceivers, and/or the like, which allow for wireless communication with the user interface(s) 140. As another example, the control unit 124 and the user interface(s) 140 can be in communication through an intermediate medium, such as through the Internet, a private communication network, and/or the like.

The tracking sub-system 122 is configured to track a current position of an aircraft 102 at an airport 104. The control unit 124 monitors the position of the aircraft 102 through data received from the tracking sub-system 122. That is, the tracking sub-system 122 tracks the position of the aircraft 102, and the control unit 124 receives such data from the tracking sub-system 122. In at least one example, the tracking sub-system 122 is an ADS-B tracking sub-system. In such an example, the ADS-B tracking sub-system 122 determines a current position of an aircraft 102 via satellite navigation through a positional signal of the aircraft 102 output by the position sensor 120, which is received by the position receiver(s) 118. The position sensor 120 can be or include a transmitter that periodically outputs information about the aircraft 102, such as identification details, current position, current altitude, and current velocity. The tracking sub-system 122 receives the transmitted position signal from the position receiver(s) 118 to determine a current and real time position, heading, velocity, and the like of the aircraft 102. Alternatively, the tracking sub-system 122 can be a radar system, GPS system, and/or other such system that is configured to track the position of the aircraft 102.

The airport map sub-system 126 includes data for maps of layouts of each airport 104. For example, the airport map sub-system 126 provides airport map data regarding the various areas of the airport 104, such as the runway(s) 106. In at least one example, the airport map sub-system 126 locates areas of the airport 104, such as the runway(s) 106, through global position system (GPS) data. In at least one other example, the airport map sub-system 126 locates areas of the airport 104 through various sensors and features that are registered or otherwise associated with the various areas of the airport 104. As another example, satellite image data can be used to identify various aspects of an airport. Optionally, the control unit 124 can monitor the position of the aircraft 102 with respect to an airport 104 without the use of separate maps. In such an example, the control unit 124 may be programmed with data regarding locations of runways 106, for example, such as through GPS signals.

Each aircraft 102 at and/or proximate to (such as within 10 miles or less) the airport(s) 104 is tracked by the tracking sub-system 122, which receives position information of the aircraft 102 from the position receiver(s) 118 at the airport(s) 104. The control unit 124 receives position data indicative of the real-time, current positions of the aircraft 102 from the tracking sub-system 122. The control unit 124 determines the position of the aircraft 102 in relation to a location of the airport 104 (such as the runway(s) 106) by correlating the position data with airport map data received from the airport map sub-system 126. As such, the control unit 124 determines a real-time, current position of the aircraft 102 at the airport 104.

In operation, the control unit 124 monitors a current position of an aircraft 102 in relation to one or more runways 106 of the airport 104. The control unit 124 determines a status of a runway 106 at the airport 104 based on the tracked positions of the aircraft 102 in relation to the runway 106. For example, the control unit 124 determines that a runway 106 is active based on one or more of a heading, speed, altitude, and/or the like of one or more aircraft 102 in relation to the runway 106 over time. If the control unit 124 determines that aircraft 102 are arriving and/or departing a runway 106 within a predetermined time threshold (such as within an hour or less), the control unit 124 identifies the runway 106 as active. In contrast, if the control unit 124 determines that aircraft 102 are not arriving and/or departing a runway 106 within the predetermined time threshold, the control unit 124 identifies the runway 106 as inactive. The control unit 124 then outputs one or more runway status signals 128. The runway status signal(s) 128 is an electronic signal including data regarding the status of the runways 106 at an airport. The runway status signal(s) 128 include data regarding active runways 106 and inactive runways 106 at the airport 104. Optionally, the runway status signal(s) 128 include data regarding only the active runways 106.

The runway status signal(s) 128 is received by one or more user interfaces 140, such as within the aircraft 102, ATC 116, and/or the like. The data included within the runway status signal(s) 128 is shown or broadcasted on and/or by the user interface 140. For example, the data can be shown on the display 142 as text, a graphic, flashing lights, and/or the like. As another example, the data can be broadcast as an audio signal through one or more speakers of the user interface 140.

In at least one example, the control unit 124 determines runway status (such as an active runway) based on a position of the aircraft 102 (such as determined through the tracking sub-system 122), a course or heading of the aircraft 102 (such as determined through the tracking sub-system 122), and a location and/or shape of the runway 106 at the airport 104 (such as determined through data in the airport map sub-system 126).

In at least one example, the control unit 124 can also utilize one or more configurable parameters. As an example, the parameters include a predetermined time period for evaluation. For example, the control unit 124 can analyze the position and heading of the aircraft 102 in relation to the runway 106 every three seconds. Optionally, the predetermined period for evaluation can be greater than three seconds, such as every five seconds. As another example, the predetermined period for evaluation can be less than three seconds, such as every second. As another example, the control unit 124 can continually monitor the position and heading of the aircraft 102 in relation to the runway 106. The predetermined period for evaluation can be variable, depending on current levels of air traffic, weather conditions, a specific layout of an airport, and/or the like.

In at least one example, the control unit 124 receives position data of the aircraft 102 in relation to an airport map. The control unit 124 may then determine a time elapsed since a last position update of the aircraft 102 in order to limit an amount of computations. The control unit 124 then adds the current position of the aircraft 102 to an aircraft position store, such as within a memory of or otherwise coupled to the control unit 124. The control unit 124 then computes a time period between a current position timestamp and a timestamp of a most recent evaluation of the aircraft 102 in relation to a runway 106. If the time period is lower than a configured time period, the process may end.

In at least one example, data regarding the identify of active and inactive runways over time can be recorded and stored in a memory, which can be part of or otherwise in communication with the control unit 124. Such information can be analyzed to determine operational aspects the airport.

As described herein, the system 100 includes the control unit 124 for automatically determining (without human intervention) status for one or more runways 106 at one or more airports 104. The control unit 124 is configured to detect one or more aspects of one or more aircraft 102 in relation to the one or more runways 106, and determine the status of the one or more runways 106 based on the one or more aspects of the one or more aircraft 102 in relation to the one or more runways 106. In at least one example, the status includes an active runway. As a further example, the status includes an active arrival runway and an active departure runway.

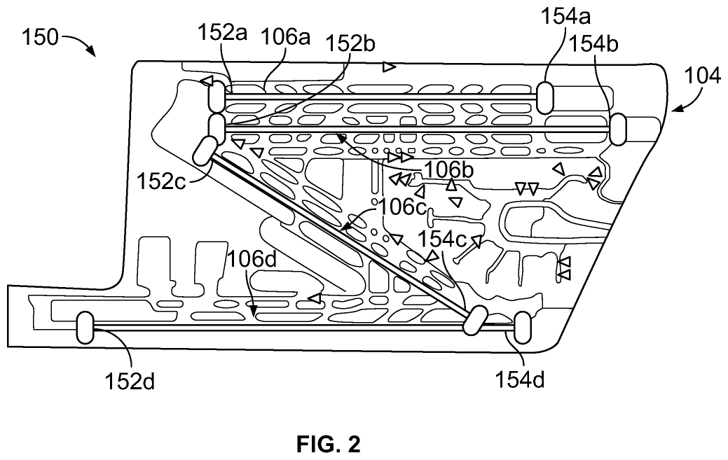

FIG. 2 illustrates a representation of an airport map 150, according to an example of the present disclosure. Referring to FIGS. 1 and 2, the control unit 124 retrieves the airport map 150 from the airport map sub-system 126, and can superimpose a position of the aircraft 102 on the airport map 150.

In the example of FIG. 2, the airport map 150 depicts an airport 104 having a first runway 106a, a second runway 106b, a third runway 106c, and a fourth runway 106d. It is to be understood that the airport 104 can include more or less runways than four.

The runway 106a includes a first end 152a and an opposite second end 154a. The runway 106b includes a first end 152b and an opposite second end 154b. The runway 106c includes a first end 152c and an opposite second end 154c. The runway 106d includes a first end 152d and an opposite second end 154d.

In at least one example, the control unit 124 determines that a particular runway 106a, 106b, 106c, or 106d in response to detecting aircraft 102 within a predetermined altitude range, predetermined speed range, and predetermined heading in relation to (for example, at and/or proximate to (such as within 500 feet)) the ends 152a-d and 154a-d. For example, if the control unit 124 determines that aircraft 102 are descending from an altitude within 500 feet at a speed of 200 miles per hour or less in relation to an end 152a, b, c, or d, then the control unit 124 can determine that particular runway 106a, b, c, or d is an active runway, in this case an active arrival runway. The control unit 124 can further track the position of the aircraft 102 in relation to the runway 106a, b, c, or d toward the opposite end 154a, b, c, or d to determine if the aircraft 102 is on the ground and decelerating toward the opposite end 154a, b, c, or d to confirm that the particular runway 106a, b, c, or d is an active arrival runway. As, such, the control unit 124 can determine that a runway 106 is an active runway, such an active arrival runway, based on one or more of an altitude, speed, heading, and/or the like of aircraft 102 in relation to the ends 152a-d and 154a-d of the runway.

As another example, if the control unit 124 determines that aircraft 102 are on the ground in relation to an end 152a, b, c, or d and accelerating toward and/or ascending in altitude toward the opposite end 154a, b, c, or d, then the control unit 124 can determine that particular runway 106a, b, c, or d is an active runway, in this case an active departure runway. As, such, the control unit 124 can determine that a runway 106 is an active runway, such an active departure runway, based on one or more of an altitude, speed, heading, and/or the like of aircraft 102 in relation to the ends 152a-d and 154a-d of the runway.

In at least one example, the control unit 124 monitors the runways 106a-d over time to confirm that the runways 106a-d are either active or inactive. For example, the control unit 124 may not identify a particular runway as active in response to only one aircraft 102 being detected in relation to the ends 152a-d and/or 154a-d. Instead, the control unit 124 may base a status of a runway in relation to a predetermined threshold number of aircraft being detected within a predetermined threshold of time. For example, in order to determine that a runway 106 is active (whether active arrival or active departure), the control unit 124 detects a predetermined number of at least three aircraft landing (or departing) within a predetermined period of three minutes. Optionally, the predetermined number of aircraft can be less or greater than three (such as two or four) and the predetermined period of time may be less or greater than three minutes (such as two minutes or five minutes). The predetermined thresholds (such as number of aircraft and time period) are stored in a memory, which can be part of the control unit 124 or in communication with the control unit 124. It is to be understood that the listed thresholds are merely examples, and various others can be used.

In at least one example, the control unit 124 may also preprogrammed (such as with respect to data stored in memory) to identify, confirm, or otherwise determine a status of a runway as active based on predetermined rules. For example, if the control unit 124 detects different aircraft 102 at opposite ends of a particular runway at the same time, then the control unit 124 determines that the particular runway is inactive, as a rule may dictate that both ends of an active runway cannot used at the same time. As an example, if the control unit 124 determines a first aircraft 102 at the end 152a of the runway 106a and a second aircraft 152 at the opposite end 154a of the runway 106a at the same time, then the control unit 124 determines that the runway 106a is not active.

As another example, a predetermined rule can be that parallel runways are not active in opposite directions. For example, if the control unit 124 determines that runways 106a and 106b are both active, the control unit 124 further determines that both cannot be used for landings and/or departures in opposite directions. Accordingly, if the control unit 124 detects such a scenario, the control unit 124 further analyzes the positions and movements of the different aircraft 102 in relation to the runways 106a and 106b to determine that one of the runways 106a or 106b is active and the other is inactive.

In at least one example, the control unit 124 continually monitors positions and movements of the aircraft 102 in relation to the runways 106a-d over time to determine a configuration change of the runways 106a-d. As an example, the control unit 124 may monitor the aircraft 102 in relation to the runways 106a-d and initially determine that the runway 106a is an active arrival runway, while the runway 106b is an active departure runway based on altitudes, speeds, and headings of the aircraft 102 in relation to the different ends 152a, b, and 154a, b. The control unit 124 may determine that after a particular period of time, that the runway 106a switched to an active departure runway, while the runway 106b switches to an active arrival runway. As another example, the control unit 124 may monitor positions of the aircraft 102 and determine that arrival and departure directions changed over time, thereby indicating a runway configuration change. The control unit 124 may indicate such configuration change(s) by data included within the runway status signal(s) 128.

The control unit 124 can continually monitor the runways 106 in relation to runway events (such as arrivals and departures) of the aircraft 102 to determine if there are any runway status conflicts. For example, each time a new runway event (such as an arrival or a departure) occurs, the control unit 124 updates a set of runways identified as active at the airport and can further take count of recent usage. If the control unit 124 detects a runway event that indicates conflicting runway usage (for example, different aircraft at opposite ends of a runway, initially determined intersecting active runways, or the like), the control unit 124 can determine a configuration change, and updates the reported set of active runways.

The system 100 provides continuous active runway information, which is not available through any other source. Current data can be provided to pilots and other airport personal with minimal latency. Further, the control unit 124 can further be in communication with historical databases regarding past uses of runways at the airports. The control unit 124 can reference historical data of past airport operations to provide a training input for predictive data services for airports.

In at least one example, the control unit 124 stores the status of the runways 106 in memory, and updates the states based on real-time runway departure and arrival events. The control unit 124 can detect configuration changes through conflicting runway usage based on runway layout at an airport.

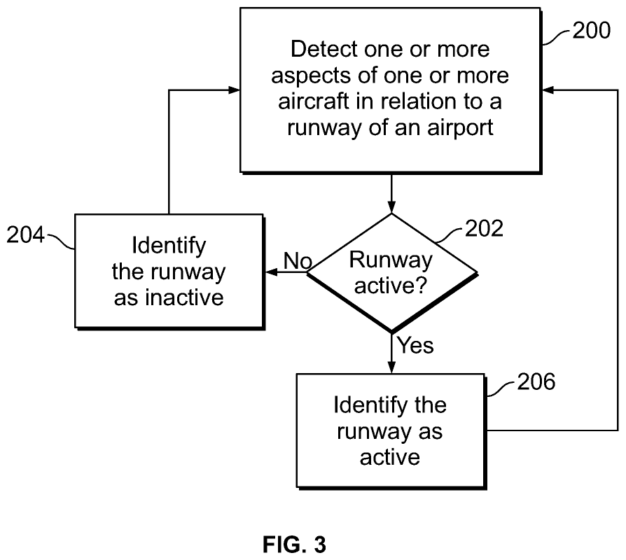

FIG. 3 illustrates a flow chart of a method, according to an example of the present disclosure. Referring to FIGS. 1 and 3, at 200, the control unit 124 detects (without human intervention) one or more aspects (such as altitude, speed, heading, and the like) of one or more aircraft 102 in relation to a runway 106 of an airport 104. Based on the aspect(s) of the aircraft 102 in relation to the runway 106, the control unit 124 determines if the runway 106 is active at 202. If the control unit 124 determines that the runway 106 is not active at 202, the method proceeds to 204, at which the control unit 124 identifies the runway 106 as inactive (and indicates the status within the runway status signal 128), and the method returns to 200. If, however, the control unit 124 determines that the runway 106 is active at 202, the method proceeds to 206, at which the control unit 124 identifies the runway 106 as active (and indicates the status within the runway status signal 128), and the method returns to 200.

In at least one other example, one or more of the aircraft 102 can be automatically operated based on the runway status signal(s) 128. For example, based on the status of the runways, the control unit 124 outputs the runway status signal(s) 128. which can then be used to automatically operate the controls of the aircraft 102 to continue movement on, toward, or away from an active runway. For example, if an aircraft 102 is on a taxiway and not cleared for movement on an active runway, the aircraft 102 can be prevented from movement onto the active runway based on the runway status signal(s) 128. The control unit 124 can continue such operation until ATC 116 clears the aircraft 102 for movement onto the active runway. As another example, the control unit 124 can monitor positions and movements of other aircraft approaching, traveling on, and/or taking off from a runway, and automatically control operation of the aircraft 102 based on positions and movements of the other aircraft. For example, when the control unit 124 determines that another aircraft is approaching the active runway to land and at a current speed will touch down in three minutes or less, the control unit 124 can prevent aircraft 102 from moving toward the runway 106 until the other aircraft has landed and moved onto a taxiway. Optionally, the control unit 124 does not automatically control aircraft 102 based on the runway status signal(s) 128.

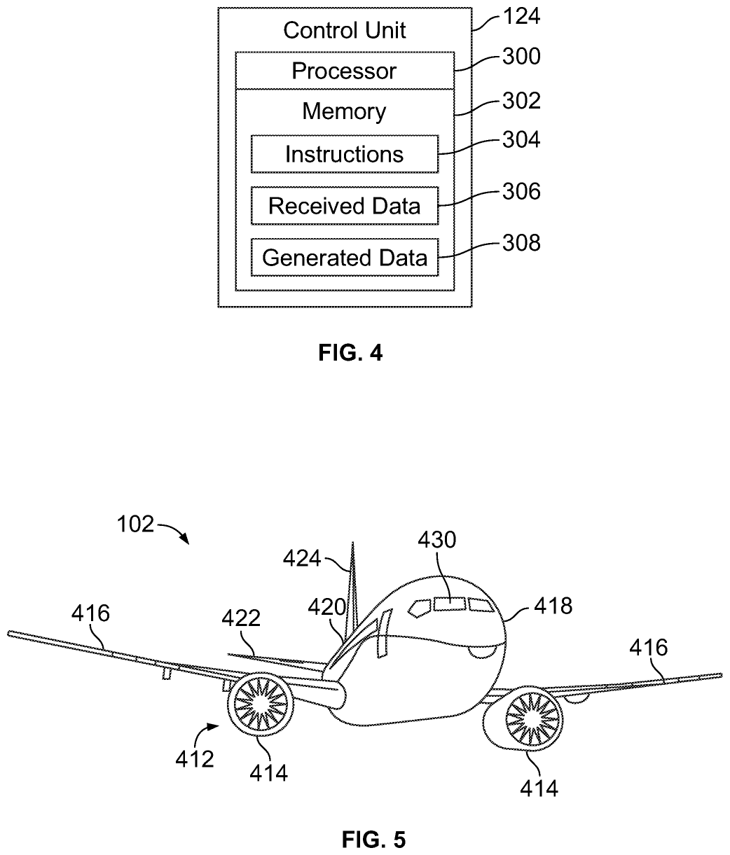

FIG. 4 illustrates a schematic block diagram of the control unit 124, according to an example of the present disclosure. In at least one example, the control unit 124 includes at least one processor 300 in communication with a memory 302. The memory 302 stores instructions 304, received data 306, and generated data 308. The control unit 124 shown in FIG. 4 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 124 may be or include one or more processors that are configured to control operation, as described herein.

The control unit 124 is configured to execute a set of instructions that are stored in one or more data storage units or elements (such as one or more memories), in order to process data. For example, the control unit 124 may include or be coupled to one or more memories. The data storage units may also store data or other information as desired or needed. The data storage units may be in the form of an information source or a physical memory element within a processing machine.

The set of instructions may include various commands that instruct the control unit 124 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 124. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 124 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-4, current runway usage, as determined by the systems and methods described herein, is helpful for situational awareness. Alerting a pilot of a runway configuration change, such as through the output runway status signal(s) 128, close to departure or arrival allows the pilot time to plan for the change proactively and not be surprised by a clearance change. Runway configuration impacts airport capacity, and configuration changes can temporarily reduce airport capacity. In relation to flight planning, an expected runway configuration informs which procedures are available. Such procedures impact the flight plan and how much fuel needs to be carried. Runway configuration change notifications, such as via the runway status signal(s) 128, allow for proactive re-planning.

Examples of the present disclosure provide systems and methods that allow large amounts of data to be quickly and efficiently analyzed by a computing device. For example, the control unit 124 can analyze various aspects of numerous aircraft 102 at numerous airports 104 during a particular time period. As such, large amounts of data, which may not be discernable by human beings, are being tracked and analyzed. The vast amounts of data are efficiently organized and/or analyzed by the control unit 124, as described herein. The control unit 124 analyzes the data in a relatively short time in order to quickly and efficiently determine the status of runways at the airport(s). A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, components of the system 100, such as the control unit 124, provide and/or enable a computer system to operate as a special computer system for determining status of runways (such as active runways) at one or more airports 104. The control unit 124 improves upon standard computing devices by determining active runways in an efficient and effective manner.

In at least one example, all or part of the systems and methods described herein may be or otherwise include an artificial intelligence (AI) or machine-learning system that can automatically perform the operations of the methods also described herein. For example, the control unit 124 can be an artificial intelligence or machine learning system. These types of systems may be trained from outside information and/or self-trained to repeatedly improve the accuracy with how data is analyzed to determine the status of runways 106 at one or more airports 104. Over time, these systems can improve by determining runway status with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of the status of runways. The training minimizes conflicts and interference by performing an iterative training algorithm, in which the systems are retrained with an updated set of data (for example, data received before, during, and/or after each flight of the aircraft 102) and based on the feedback examined prior to the most recent training of the systems. This provides a robust analysis model that can better determine runway status in a cost effective and efficient manner.

FIG. 5 illustrates a perspective front view of an aircraft 102, according to an example of the present disclosure. The aircraft 102 includes a propulsion system 412 that includes engines 414, for example. Optionally, the propulsion system 412 may include more engines 414 than shown. The engines 414 are carried by wings 416 of the aircraft 102. In other examples, the engines 414 may be carried by a fuselage 418 and/or an empennage 420. The empennage 420 may also support horizontal stabilizers 422 and a vertical stabilizer 424. The fuselage 418 of the aircraft 102 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 102. It is to be understood that the aircraft 102 can be sized, shaped, and configured differently than shown in FIG. 5.

Further, the disclosure comprises examples according to the following clauses:

Clause 1. A system comprising:
a control unit for determining status for one or more runways at one or more airports, the control unit configured to:
   detect one or more aspects of one or more aircraft in relation to the one or more runways, and
   determine the status of the one or more runways based on the one or more aspects of the one or more aircraft in relation to the one or more runways.

Clause 2. The system of Clause 1, wherein the status of the one or more runways includes an active runway.

Clause 3. The system of Clauses 1 or 2, wherein the status of the one or more runways includes an active arrival runway and an active departure runway.

Clause 4. The system of any of Clauses 1-3, wherein the one or more runways include a plurality of runways, and wherein the one or more airports include one airport.

Clause 5. The system of any of Clauses 1-4, wherein the one or more runways include a plurality of runways, and wherein the one or more airports include a plurality of airports.

Clause 6. The system of any of Clauses 1-5, wherein the one or more aspects comprise altitude, speed, and heading.

Clause 7. The system of any of Clauses 1-6, wherein the control unit is configured to determine the status based on a plurality of aircraft in relation to the one or more runways within a predetermined time threshold.

Clause 8. The system of any of Clauses 1-7, wherein the control unit is configured to determine the status of the one or more runways as one or both of an active arrival runway or an active departure runway based on the one or more aspects of the one or more aircraft in relation to opposite ends of the one or more runways.

Clause 9. The system of any of Clauses 1-8, wherein the control unit is configured to determine that a runway is inactive in response to detecting different aircraft at opposite ends of the runway at the same time.

Clause 10. The system of any of Clauses 1-9, wherein the control unit is configured to determine that two different parallel runways are not active in opposite directions.

Clause 11. The system of any of Clauses 1-10, wherein the control unit is further configured to determine a configuration change of the one or more runways based on the one or more aspects of the one or more aircraft in relation to the one or more runways over time.

Clause 12. The system of any of Clauses 1-11, wherein the control unit is further configured to output one or more runway status signals including data regarding the status of the one or more runways.

Clause 13. The system of Clause 12, wherein one or more of the aircraft are automatically operated based on the one or more runway status signals.

Clause 14. The system of any of Clauses 1-13, wherein the control unit is an artificial intelligence or machine learning system.

Clause 15. A method comprising:
detecting, by a control unit for determining status for one or more runways at one or more airports, one or more aspects of one or more aircraft in relation to the one or more runways; and
determining, by the control unit, the status of the one or more runways based on the one or more aspects of the one or more aircraft in relation to the one or more runways.

Clause 16. The method of Clause 15, wherein the status of the one or more runways includes an active arrival runway and an active departure runway.

Clause 17. The method of Clauses 15 or 16, wherein said determining comprises determining the status based on a plurality of aircraft in relation to the one or more runways within a predetermined time threshold.

Clause 18. The method of any of Clauses 15-17, wherein said determining comprises determining the status of the one or more runways as one or both of an active arrival runway or an active departure runway based on the one or more aspects of the one or more aircraft in relation to opposite ends of the one or more runways.

Clause 19. The method of any of Clauses 15-18, wherein said determining comprises:
determining that a runway is inactive in response to detecting different aircraft at opposite ends of the runway at the same time; and
determining that two different parallel runways are not active in opposite directions.

Clause 20. The method of any of Clauses 15-19, further comprising determining, by the control unit, a configuration change of the one or more runways based on the one or more aspects of the one or more aircraft in relation to the one or more runways over time.

Clause 21. The method of any of Clauses 15-20, further comprising outputting, by the control unit, one or more runway status signals including data regarding the status of the one or more runways.

Clause 22. The method of Clause 21, further comprising automatically operating one or more of the aircraft based on the one or more runway status signals.

Clause 23. A non-transitory computer-readable storage medium comprising executable instructions that, in response to execution, cause one or more control units comprising a processor, to perform operations comprising:
detecting one or more aspects of one or more aircraft in relation to one or more runways of one or more airports; and
determining the status of the one or more runways based on the one or more aspects of the one or more aircraft in relation to the one or more runways.

As described herein, examples of the present disclosure provide efficient, effective, reliable, and accurate systems and methods for identifying active runways at airports.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first.” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit for determining status for one or more runways at one or more airports, the control unit configured to:
detect one or more aspects of one or more aircraft in relation to the one or more runways, and
determine the status of the one or more runways based on the one or more aspects of the one or more aircraft in relation to the one or more runways.

2. The system of claim 1, wherein the status of the one or more runways includes an active runway.

3. The system of claim 1, wherein the status of the one or more runways includes an active arrival runway and an active departure runway.

4. The system of claim 1, wherein the one or more runways include a plurality of runways, and wherein the one or more airports include one airport.

5. The system of claim 1, wherein the one or more runways include a plurality of runways, and wherein the one or more airports include a plurality of airports.

6. The system of claim 1, wherein the one or more aspects comprise altitude, speed, and heading.

7. The system of claim 1, wherein the control unit is configured to determine the status based on a plurality of aircraft in relation to the one or more runways within a predetermined time threshold.

8. The system of claim 1, wherein the control unit is configured to determine the status of the one or more runways as one or both of an active arrival runway or an active departure runway based on the one or more aspects of the one or more aircraft in relation to opposite ends of the one or more runways.

9. The system of claim 1, wherein the control unit is configured to determine that a runway is inactive in response to detecting different aircraft at opposite ends of the runway at the same time.

10. The system of claim 1, wherein the control unit is configured to determine that two different parallel runways are not active in opposite directions.

11. The system of claim 1, wherein the control unit is further configured to determine a configuration change of the one or more runways based on the one or more aspects of the one or more aircraft in relation to the one or more runways over time.

12. The system of claim 1, wherein the control unit is further configured to output one or more runway status signals including data regarding the status of the one or more runways.

13. The system of claim 12, wherein one or more of the aircraft are automatically operated based on the one or more runway status signals.

14. The system of claim 1, wherein the control unit is an artificial intelligence or machine learning system.

15. A method comprising:
detecting, by a control unit for determining status for one or more runways at one or more airports, one or more aspects of one or more aircraft in relation to the one or more runways; and
determining, by the control unit, the status of the one or more runways based on the one or more aspects of the one or more aircraft in relation to the one or more runways.

16. The method of claim 15, wherein the status of the one or more runways includes an active arrival runway and an active departure runway.

17. The method of claim 15, wherein said determining comprises determining the status based on a plurality of aircraft in relation to the one or more runways within a predetermined time threshold.

18. The method of claim 15, wherein said determining comprises determining the status of the one or more runways as one or both of an active arrival runway or an active departure runway based on the one or more aspects of the one or more aircraft in relation to opposite ends of the one or more runways.

19. The method of claim 15, wherein said determining comprises:
determining that a runway is inactive in response to detecting different aircraft at opposite ends of the runway at the same time; and
determining that two different parallel runways are not active in opposite directions.

20. A non-transitory computer-readable storage medium comprising executable instructions that, in response to execution, cause one or more control units comprising a processor, to perform operations comprising:
detecting one or more aspects of one or more aircraft in relation to one or more runways of one or more airports; and
determining the status of the one or more runways based on the one or more aspects of the one or more aircraft in relation to the one or more runways.
